(19) United States
(12) Patent Application Publication
(10) Pub. No.: US 2016/0147810 A1
(43) Pub. Date: May 26, 2016

(54) Recommending Users to a Social Networking System User Based on Relevance and Similarity Between Users

(71) Applicant: Facebook, Inc., Menlo Park, CA (US)

(72) Inventors: Margaret-Ann Julia Seger, San Francisco, CA (US); Rodrigo M. Schmidt, Sunnyvale, CA (US); Japinder Singh, Cupertino, CA (US); Renbin Peng, San Jose, CA (US)

(21) Appl. No.: 14/553,639

(22) Filed: Nov. 25, 2014

(51) Int. Cl. G06F 17/30; H04L 29/06

(52) U.S. Cl. CPC G06F 17/30345; H04L 65/403; G06F 17/30876

(57) ABSTRACT

A social networking system allows users to establish connections with other users to receive content provided to the social networking system by the other user. The social networking system may recommend an additional user to the user in response to the user establishing a connection with a target user. To recommend an additional user, the social networking system determines a relevance of the additional user to the target user relative to the relevance of other candidate users to the target user. The relevance may be based on a measure of similarity between an additional user and the target user, such as a covariance in the overlap of users connected to both the additional user and to the target user.

### BACKGROUND

This disclosure relates generally to social networking systems, and more specifically to recommending social networking system users to other social networking system users based on connections of various users.

A social networking system allows its users to connect to and communicate with other social networking system users. For example, a social networking system allows a user to request establishment of a connection to another user. Based on the request, the social networking system may establish a connection between the user and the other user, with a connection between users allowing the users to exchange content and other information.

As many social networking systems have a large number of users, it is often difficult for social networking system users to identify additional social networking system users with which to establish a connection. While many conventional social networking systems recommend additional users to a user, these conventional social networking systems merely identify users connected to other users connected to the user as potential users with which the user may establish a connection. However, this may result in a user being recommended to establish connections with other users that are similar to the user, and this similarity between connected users may decrease the user's interaction with the social networking system.

### SUMMARY

Users of a social networking system establish connections with each other to share content. The social networking system establishes a connection between a user and a target user. This connection may be established based on a request from the user to establish the connection with the target user or based on an action taken by the user. For example, the user selects an interface element presented by the social networking system to “follow” the target user and the social networking system establishes a connection between the user and the target use in response to the user's selection.

To allow the user to more easily establish connections to additional users, the social networking system may recommend additional users with which the user may establish a connection in response to the user establishing a connection. Increasing the number of other users connected to the user may increase the user's interaction with the social networking system. In response to the user establishes a connection to the target user, the social networking system identifies one or more candidate users having at least a threshold relevance to the target user. Candidate users are additional users of the social networking system that are not already connected to (e.g., followed by) the user. A relevance of an additional user to the target user represents a similarity between the target user and the additional user. Various characteristics of an additional user and of the target user may be used to determine the relevance of the additional user to the target user. For example, a relevance of an additional user to the target user is based on keywords in user profile information of the target user and the additional user, events associated with the target user and the additional user, users connected to the target user and to the additional user, keywords in posts or messages of the target user and the additional user, timestamps of posts or messages of the target user and the additional user, locations associated with the target user and the additional user, or any other data common to the target user and to the additional user. In another embodiment, the relevance of an additional user to the target user may be based on information associated with the target user. For example, if the target user specifies an occupation of celebrity, a candidate user is another user having an occupation of celebrity or having another similar occupation. The threshold relevance specifies a minimum relevance of an additional user to the target user for the additional user to be identified as a candidate user.

Measures of similarity are determined between each candidate user and the target user. A measure of similarity between a candidate user and the target user is based at least in part on social networking system users connected to the candidate user and also connected to the target user. For example, a measure of similarity between a candidate user and the target user is based on one or more of: a measure of covariance in the overlap of users connected to both the candidate user and the target user, a measure of covariance of overlapping user profile information associated with users connected to both the candidate user and the target user, additional users connected to the users following both the target user and candidate user or any combination thereof. Based at least in part on the measures of similarity, a recommended user is selected from the candidate users. In one embodiment, the recommended user is a candidate user associated with a maximum measure of similarity. However, in other embodiments, candidate users having at least a threshold measure of similarity are selected as recommended users.

The social networking system identifies the recommended user (or recommended users) to the user. For example, a user identifier or other information associated with the recommended user presented to the user along with content suggesting the user establish a connection to the recommended user. Information describing one or more reasons for identifying the recommended user to the user may also be presented to the user. For example, information identifying the target user and indicating to the user that the recommended user is identified in response to the user requesting to establish a connection to or establishing a connection to the target user.

### BRIEF DESCRIPTION OF THE DRAWINGS

FIG. 1 is a block diagram of a system environment in which a social networking system operates, in accordance with an embodiment.

FIG. 2 is a block diagram of a social networking system, in accordance with an embodiment.

FIG. 3 is a flowchart of a method for determining an additional user to recommend to a social networking system user based on a target user connected to the user, in accordance with an embodiment.

FIG. 4 is a conceptual diagram depicting connections between a user, a target user, and candidate users, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

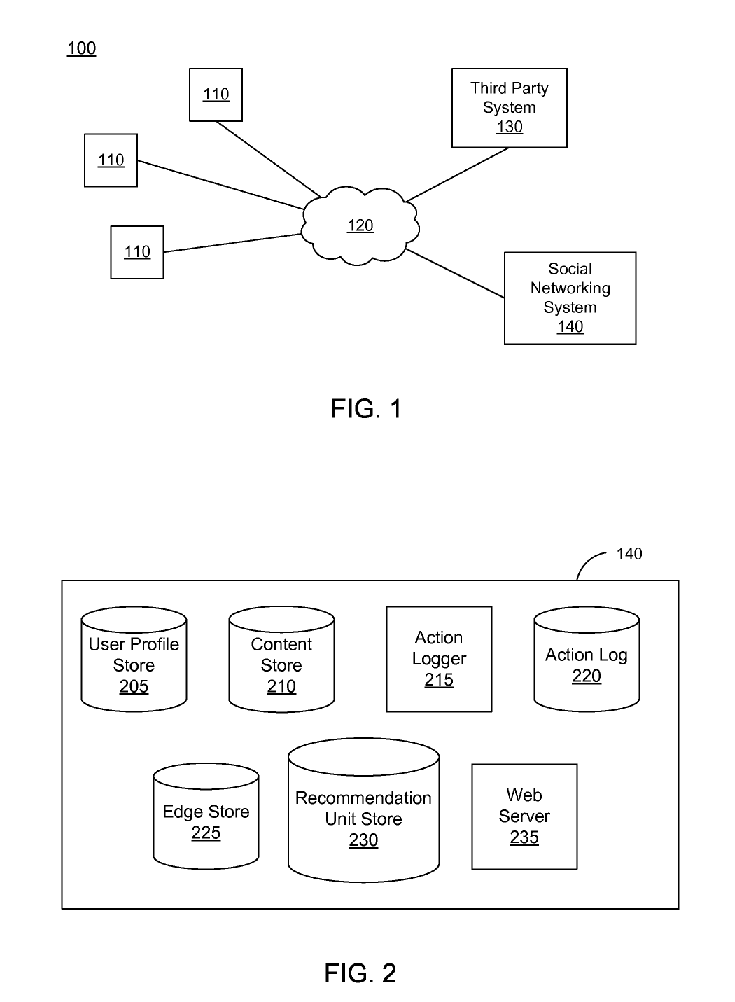

FIG. 1 is a block diagram of a system environment 100 for a social networking system 140. The system environment 100 shown by FIG. 1 comprises one or more client devices 110, a network 120, one or more third-party systems 130, and the social networking system 140. In alternative configurations, different and/or additional components may be included in the system environment 100. The embodiments described herein can be adapted to online systems that are not social networking systems.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the social networking system 140. For example, a client device 110 executes a browser application to enable interaction between the client device 110 and the social networking system 140 via the network 120. In another embodiment, a client device 110 interacts with the social networking system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the social networking system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the social networking system 140, such as advertisements, content, or information about an application provided by the third party system 130.

FIG. 2 is a block diagram of an architecture of the social networking system 140. The social networking system 140 shown in FIG. 2 includes a user profile store 205, a content store 210, an action logger 215, an action log 220, an edge store 225, a recommendation unit store 230, a connection recommendation module 235, and a web server 240. In other embodiments, the social networking system 140 may include additional, fewer, or different components for various applications. Conventional components such as network interfaces, security functions, load balancers, failover servers, management and network operations consoles, and the like are not shown so as to not obscure the details of the system architecture.

Each user of the social networking system 140 is associated with a user profile, which is stored in the user profile store 205. A user profile includes declarative information about the user that was explicitly shared by the user and may also include profile information inferred by the social networking system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the social networking system 140, user profiles may also be stored for entities such as businesses or organizations. This allows an entity to establish a presence on the social networking system 140 for connecting and exchanging content with other social networking system users. The entity may post information about itself, about its products or provide other information to users of the social networking system using a brand page associated with the entity's user profile. Other users of the social networking system may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Social networking system users may create objects stored by the content store 210, such as status updates, photos tagged by users to be associated with other objects in the social networking system 140, events, groups or applications. In some embodiments, objects are received from third-party applications or third-party applications separate from the social networking system 140. In one embodiment, objects in the content store 210 represent single pieces of content, or content “items.” Hence, social networking system users are encouraged to communicate with each other by posting text and content items of various types of media to the social networking system 140 through various communication channels. This increases the amount of interaction of users with each other and increases the frequency with which users interact within the social networking system 140.

The action logger 215 receives communications about user actions internal to and/or external to the social networking system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the social networking system 140 to track user actions on the social networking system 140, as well as actions on third party systems 130 that communicate information to the social networking system 140. Users may interact with various objects on the social networking system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects on the social networking system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the social networking system 140 as well as with other applications operating on the social networking system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the social networking system 140. For example, an e-commerce website may recognize a user of a social networking system 140 through a social plug-in enabling the e-commerce website to identify the user of the social networking system 140. Because users of the social networking system 140 are uniquely identifiable, e-commerce websites, such as in the preceding example, may communicate information about a user's actions outside of the social networking system 140 to the social networking system 140 for association with the user. Hence, the action log 220 may record information about actions users perform on a third party system 130, including webpage viewing histories, advertisements that were engaged, purchases made, and other patterns from shopping and buying.

In one embodiment, the edge store 225 stores information describing connections between users and other objects on the social networking system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 140, such as expressing interest in a page on the social networking system 140, sharing a link with other users of the social networking system 140, and commenting on posts made by other users of the social networking system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the social networking system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the social networking system 140 over time to approximate a user's interest in an object or another user in the social networking system 140 based on the actions performed by the user. A user's affinity may be computed by the social networking system 140 over time to approximate a user's interest for an object, interest, or other user in the social networking system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The recommendation unit store 230 stores recommendation units for users of the social networking system 140. The social networking system 140 provides one or more recommendation units to its users to increase user interaction with the social networking system 140. A recommendation unit suggests one or more actions to a user viewing the recommendation unit (a “viewing user”) to increase the viewing user's interaction with the social networking system. For example, a recommendation unit provides a suggestion for the viewing user to establish a connection with another user as well as a link enabling the user to do so. In other examples, a recommendation unit encourages the viewing user to invite an additional user to an event, to identify a user in a photo, to join a group, or to perform another suitable action with the social networking system 140. Each recommendation unit is associated with a score based on a value of the viewing user interacting with the recommendation unit (i.e., “converting” the recommendation unit by performing the recommended action) and/or on the likelihood that the viewing user will convert the recommendation unit. The score may be based on prior interaction with recommendation units by the viewing user, other users to whom the viewing user is connected, a probability of the viewing user interacting with the recommendation unit, or other criteria. Determination of a score for a recommendation unit is further described in U.S. patent application Ser. No. 13/549,080, filed on Jul. 13, 2012, which is hereby incorporated by reference in its entirety. The social networking system 140 selects one or more recommendation units to send to a user based at least in part on this score. The social networking system 140 may also select one or more recommendation units stored in the recommendation unit store 230 based on other a user to which the user is connected, also referred to herein as a “target user.”

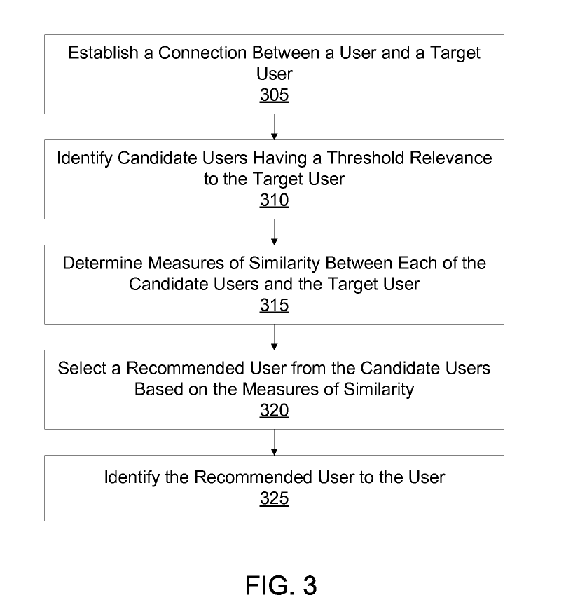

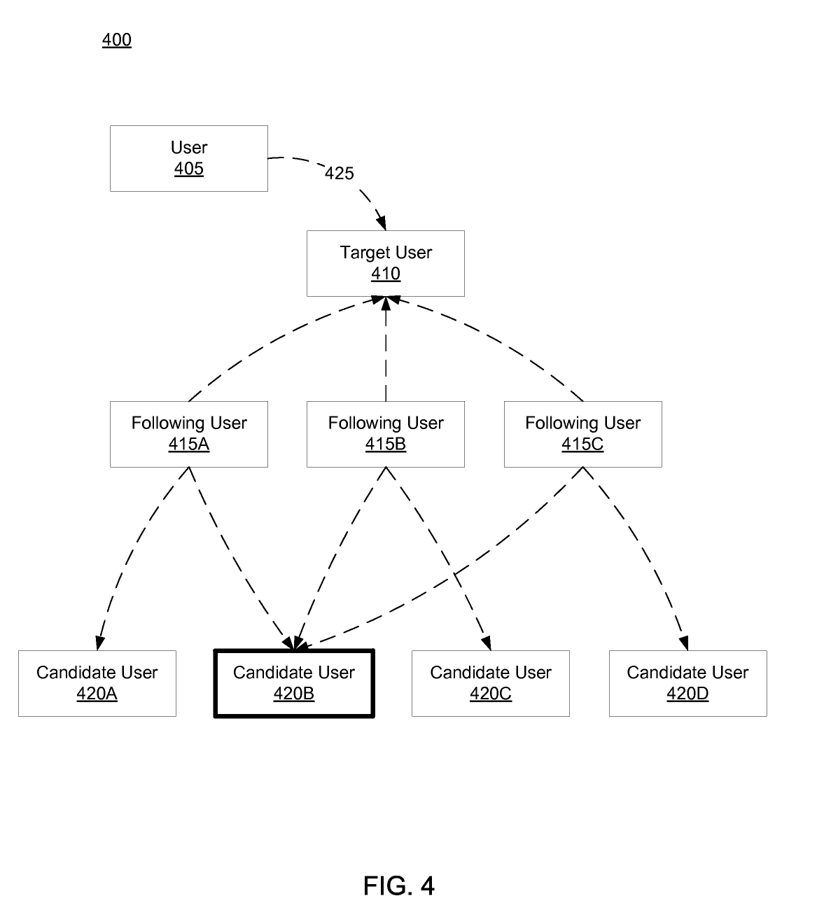

A recommendation unit may suggest that a user establish a connection with an additional user of the social networking system 140. The connection recommendation module 235 identifies the additional user identified by the recommendation unit based on information associated with the user. In one embodiment, the connection recommendation module 235 identifies a target user to which the user is connected based on information in the user profile store 205 and in the edge store 225. Based on information associated with the target user, the connection recommendation module 235 identifies candidate users that are not connected to the user. As further described below in conjunction with FIGS. 3 and 4, candidate users are identified as additional users having at least a threshold relevance to the target user. The relevance of an additional user to the target user provides an indication of similarity between the additional user and the target user. Characteristics of an additional user may be compared to characteristics of the target user to determine the relevance of the additional user to the target user. Measures of similarity between each candidate user and the target user are determined, with a recommended user selected for identification by the recommendation unit based on the measures of similarity, as further described above in conjunction with FIG. 3. A measure of similarity between a candidate user and the target user, further described below in conjunction with FIG. 3, is based at least in part on social networking system users connected to the candidate user and also connected to the target user.

The web server 240 links the social networking system 140 via the network 120 to the one or more client devices 110, as well as to the one or more third party systems 130. The web server 240 serves web pages, as well as other content, such as JAVA®, FLASH®, XML and so forth. The web server 240 may receive and route messages between the social networking system 140 and the client device 110, for example, instant messages, queued messages (e.g., email), text messages, short message service (SMS) messages, or messages sent using any other suitable messaging technique. A user may send a request to the web server 240 to upload information (e.g., images or videos) that are stored in the content store 210. Additionally, the web server 240 may provide application programming interface (API) functionality to send data directly to native client device operating systems, such as IOS®, ANDROID™, WEBOS® or BlackberryOS.

Recommending a User from Candidate Users Based on a Target User

FIG. 3 is a flowchart of one embodiment of a method for determining an additional user to recommend to a social networking system user based on a target user connected to the user. In other embodiments, the method may include different and/or additional steps than those shown in FIG. 3. Additionally, steps of the method may be performed in different orders than the order described in conjunction with FIG. 3.

The social networking system 140 establishes 305 a connection between a user of the social networking system 140 and a target user of the social networking system 140. The connection may be established 305 based on a request from or an action taken by the user to connect with the target user. For example, the user selects an interface element presented by the social networking system 140 to “follow” the target user, and the social networking system 140 establishes 305 a connection between the user and the target user based on the user's selection. Additional actions the user may take for the social networking system 140 to establish 305 a connection between the user and the target user include interactions with interface elements (such as recommendation units) prompting the user to express a preference for the target user (i.e., “like” the target user), to communicate content with the target user, or to access content provided by the target user via the social networking system. The target user may be any type of user having a user profile maintained by the social networking system 140. Example types of users include a celebrity, a public figure, or any other information describing a user. When the connection between the user and the target user is established 305, the social networking system 140 presents content associated with the target user to the user via a user interface. For example, the social networking system 140 includes content items provided to the social networking system 140 by the target user, content items with which the target user has interacted, or content items identifying the target user in a feed of content items presented to the user.

In response to establishing 305 the connection between the user and the target user, the social networking system 140 identifies 310 one or more candidate users having at least a threshold relevance to the target user. Candidate users are additional users of the social networking system 140 that are not connected to the user. The social networking system 140 determines a relevance between various additional users and the target user, then identifies 310 additional users having at least a threshold relevance to the target user as candidate users. The relevance between of an additional user to the target user provides an indication of similarity between the additional user and the target user. Relevance between the additional user and the target user may be determined based on user profile information of the additional user and the target user, events associated with the additional user and the target user, other users connected to the additional user and to the target user, content communicated between the additional user and the target user, metadata of content communicated between the additional user and the target user, locations associated with the additional user and the target user, or any other information common to the target user and the additional user. In some embodiments, information associated with the user may also be used when determining relevance between an additional user and the target user to which the user has established a connection.

For example, relevance between an additional user and the target user is based on user profile information (e.g., interests, places visited, associated locations, posts, occupation, work history) included in the user profiles associated with the additional user and the target user. As a specific example, if the target user's user profile identifies the target user as a celebrity, an additional user identifying itself as a celebrity (e.g., through work history, occupation, or other information) in its associated user profile is determined to have a threshold relevance to the target user. An additional user having one or more types of user information matching user information associated with the target user may be determined to have the threshold relevance to the target user. Example types of user information for matching between the target user and an additional user include: life events, attended events, events to which an invitation was received, locations of events, or any combination thereof. In some embodiments, the relevance between an additional user and the target user may be based on connections between other users and the additional user and the target user. For example, an additional user has a threshold relevance to the target user if at least a threshold number of users are connected to the target user and to the additional user.

Content provided to the social networking system by an additional user and by the target user may also be analyzed to determine relevance of the additional user to the target user. For example, interactions by other users with content provided to the social networking system 140 by the target user or by the additional user, overlapping times associated with content provided to the social networking system 140 by the additional user and by the target user, overlapping information (e.g., topics, other users) in content provided to the social networking system 140 by the additional user and in content provided to the social networking system 140 by the target user, messages from the target user to other users, messages from the additional user to other users, or any other suitable information. Locations associated with the target user and an additional user may be used to determine the relevance of the additional user to the target user. For example, locations associated with content provided by the target user or provided by the additional user, locations associated with events associated with the target user or with the additional user, or locations associated with any other action or information associated with the target user or with the additional user may be analyzed to determine the relevance of the additional user to the target user. Other information common to the target user and to an additional user for determining relevance may include similarity in content viewed by the target user and by the additional user or actions taken by the target user and an additional user.

After identifying candidate users as additional users with at least the threshold relevance to the target user, the social networking system 140 determines 315 measures of similarity between each candidate user and the target user. A measure of similarity between a candidate user and the target user is based at least in part on users of the social networking system 140 connected to the candidate user and connected to the target user. For example, a measure of similarity between a candidate user and the target user is based on a measure of covariance in the users connected to both the candidate user and to the target user. A measure of similarity between a candidate user and the target user may also be based on a measure of covariance in overlapping user profile information associated with the users connected to both the candidate user and to the target user. As another example, a measure of similarity between a candidate user and the target user may be based on a measure of covariance in other users connected to one or more users that are connected to both the target user and to the candidate user (or to the user). For example, the measure of overlap identifies a number or percentage of users connected to the target user that are also connected to the candidate user, a percentage or amount of user information associated with the candidate user that matches user information associated with the target user, or any other suitable value measuring information associated with both the target user and the candidate user (i.e., overlapping information between the target user and the candidate user). In other embodiments, a measure of similarity between a candidate user and the target user is based on information similar to the information used to determine relevance between the candidate user and the target user. Measures of similarity may be differently determined 315 differently for different candidate users and may be based on any information maintained by the social networking system 140 and associated with a candidate user.

The social networking system 140 may account for characteristics of the user when determining 315 measure of similarity between candidate users and the target user. For example, the measure of similarity between a candidate user and the target user is based on a number of users having at least a threshold number of characteristics matching characteristics of the user and also connected to both the target user and the candidate user. Example characteristics of a user include a location, a gender, an age range, an occupation, and an interest.

Based at least in part on the measures of similarity, a recommended user is selected 320 from the candidate users. In one embodiment, the recommended user is selected 320 as the candidate user having a maximum measure of similarity. In alternative embodiments, the recommended user is selected 320 as a user having at least a threshold measure of similarity. Further, in some embodiments, the social networking system 140 may select 320 multiple recommended users from the candidate users based on the measures of similarity. For example, the social networking system 140 selects 320 recommended users as candidate users associated with at least a threshold measure of similarity. As another example, the social networking system 140 ranks the candidate users based at least in part on their associated measures of similarity and selects 320 recommended users as candidate users having at least a threshold position in the ranking.

In some embodiments, additional information may be used when selecting 320 the recommended user. For example, the social networking system may determine or retrieve a measure of quality of content provided to the social networking system by various candidate users and select 320 the recommended user based on the measures of similarity and the measure of quality of content. A measure of quality of content may be based on a number of interactions with content, a number of discrete social networking system users who interacted with content, a ratio of a type of interaction with content to total interactions with content, or any other suitable information.

The social networking system 140 identifies 325 the recommended user (or the recommended users) to the user. For example, the social networking system presents information identifying the recommended user (e.g., a user name, a profile picture, a user identifier) along with a suggestion to establish a connection to the recommended user. If multiple recommended users are selected 320, the social networking system 140 may identify 325, information describing a set of the recommended users is identified 325 to the user along with a suggestion to establish a connection to one or more of the recommended users in the set. One or more reasons for identifying 325 the recommended user may also be presented to the user. For example the social networking system 140 may indicate to the user that the recommended user is recommended because the user established a connection to the target user or requested establishment of a connection with the target user. In some embodiments, a recommendation unit from the recommendation unit store 230 is used to identify 325 the recommended user to the user. Hence, the social networking system 140 presents information identifying the recommended user to the user via a user interface after establishing 305 the connection between the user and the target user.

### Connection Diagram Between a User, a Target User, and Candidate Users

FIG. 4 is a conceptual diagram depicting connections between users in the social networking system 140 and is described with respect to FIG. 3. Specifically, connections between a user, a target user, and candidate users are identified by FIG. 4. In the example of FIG. 4, a user 405 establishes 305 a connection 425 to a target user 410. For example, the user 405 selects an interface element to establish a connection to the target user 410. For purposes of discussion, the target user 410 is a famous musician and the user 405 establishes the connection 425 with the target user 410 to receive information the target user 410 provides to the social networking system 140.

After the social networking system 140 establishes 305 the connection 425 from the user 405 to the target user 410, the social networking system 140 identifies 310 candidate users 420A, 420B, 420C, and 420D as having a threshold relevance to the target user 410, as described above in conjunction with FIG. 3. In the example of FIG. 4, the target user 410 is a famous musician, so candidate users 420A, 420B, 420C, and 420D have a threshold relevance to the target user 410 because the candidate users 420A, 420B, 420C, and 420D are also famous performers, such as musicians and actors. The user 405 has not established a connection with the candidate users 420A, 420B, 420C, and 420D.

To select 320 a recommended user from the candidate users 420A, 420B, 420C, and 420D, the social networking system 140 determines 315 measures of similarity between each candidate user 420A, 420B, 420C, and 420D and the target user 410. In this embodiment, the measure of similarity between a candidate user 420 and the target user 410 is based on a number of users connected to the candidate user 420 and also connected to the target user 410. One user, following user 415A, is connected to both candidate user 420A and the target user 410. Three users, following users 415A, 415B, and 415C, are connected to both the candidate user 420B and the target user 410, while one user, following user 415B, is connected to both the candidate user 420C and the target user 410. In the example of FIG. 4, one user, following user 415C, is connected to both the candidate user 420D and the target user 410. Hence, in this example, of the candidate users 420, the candidate user 420B has the most users connected to have the most users connected to itself and to the target user 410, so the candidate user 420B has the maximum measure of similarity with the target user 410, and is selected 320 as a recommended user identified 325 to the user.

### SUMMARY

The foregoing description of embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of embodiments is intended to be illustrative, but not limiting, of the scope of the patent rights, which is set forth in the following claims.

What is claimed is:

1. A method comprising:
establishing a connection between a user of a social networking system with a target user of the social networking system, the connection causing the user to be presented with content provided to the social networking system via a user interface provided to the user by the social networking system;
responsive to establishing the connection between the user and the target user:
determining a relevance of one or more additional users to the target user, the determined relevance between an additional user and the target user based on information associated with the target user and information associated with the additional user;
identifying one or more candidate users having at least a threshold relevance to the target user from the one or more additional users;
determining measures of similarity between each of the candidate users and the target user, a measure of similarity between a candidate user and the target user based at least in part on users of the social networking system connected to the candidate user and connected to the target user;
selecting a recommended user from the candidate users based at least in part on the measures of similarity; and
identifying the recommended user to the user via the user interface following establishment of the connection.

2. The method of claim 1, wherein information associated with the target user is selected from a group consisting of: user profile information, actions associated with the target user by the social networking system, connections between the target user and other users of the social networking system, content provided to the social networking system by the target user, and any combination thereof.

3. The method of claim 1, wherein information associated with the additional user is selected from a group consisting of: user profile information, actions associated with the additional user by the social networking system, connections between the additional user and other users of the social networking system, content provided to the social networking system by the additional user, and any combination thereof.

4. The method of claim 1, wherein a measure of similarity between the candidate user and the target user is a covariance of users connected to the candidate user and also connected to the target user.

5. The method of claim 1, wherein a measure of similarity between the candidate user and the target user is a covariance of overlapping user profile information associated with users connected to both the candidate user and to the target user.

6. The method of claim 1, wherein a measure of similarity between the candidate user and the target user is a covariance in overlapping user profile information associated with other users connected to one or more users that are connected to both the target user and to the candidate user.

7. The method of claim 1, wherein the recommended user is also selected based at least in part on the relevance of the recommended user to the target user.

8. The method of claim 1, wherein selecting the recommended user from the candidate users based at least in part on the measures of similarity comprises:
selecting a candidate user associated with a maximum measure of similarity.

9. The method of claim 1, wherein selecting the recommended user from the candidate users based at least in part on the measures of similarity comprises:
selecting a candidate user associated with a measure of similarity equaling or exceeding a threshold measure of similarity.

10. The method of claim 9, wherein the threshold measure of similarity is determined based at least in part on one or more of a group consisting of: other users connected to the user, information in a user profile associated with the user, and any combination thereof.

11. The method of claim 1, wherein identifying the recommended user to the user comprises:
identifying the target user to the user along with the identified recommended user.

12. The method of claim 1, wherein identifying the recommended user to the user comprises:
identifying information associated with the target user and a suggestion to establish a connection to the recommended user to the user.

13. A computer program product comprising a computer-readable storage medium having instructions encoded thereon that, when executed by a processor, cause the processor to:
establish a connection between a user of a social networking system with a target user of the social networking system, the connection causing the user to be presented with content provided to the social networking system via a user interface provided to the user by the social networking system;
responsive to establishing the connection between the user and the target user:
determine a relevance of one or more additional users to the target user, the determined relevance between an additional user and the target user based on information associated with the target user and information associated with the additional user;
identify one or more candidate users having at least a threshold relevance to the target user from the one or more additional users;
determine measures of similarity between each of the candidate users and the target user, a measure of similarity between a candidate user and the target user based at least in part on users of the social networking system connected to the candidate user and connected to the target user;
select a recommended user from the candidate users based at least in part on the measures of similarity; and
identify the recommended user to the user via the user interface following establishment of the connection.

14. The computer program product of claim 13, wherein information associated with the target user is selected from a group consisting of: user profile information, actions associated with the target user by the social networking system, connections between the target user and other users of the social networking system, content provided to the social networking system by the target user, and any combination thereof.

15. The computer program product of claim 13, wherein information associated with the additional user is selected from a group consisting of: user profile information, actions associated with the additional user by the social networking system, connections between the additional user and other users of the social networking system, content provided to the social networking system by the additional user, and any combination thereof.

16. The computer program product of claim 13, wherein a measure of similarity between the candidate user and the target user is a covariance of users connected to the candidate user and also connected to the target user.

17. The computer program product of claim 13, wherein a measure of similarity between the candidate user and the target user is a covariance of overlapping user profile information associated with users connected to both the candidate user and to the target user.

18. The computer program product of claim 13, wherein a measure of similarity between the candidate user and the target user is a covariance in overlapping user profile information associated with other users connected to one or more users that are connected to both the target user and to the candidate user.

19. The computer program product of claim 13, wherein select the recommended user from the candidate users based at least in part on the measures of similarity comprises:
select a candidate user associated with a maximum measure of similarity.

20. The computer program product of claim 13, wherein identify the recommended user to the user comprises:
identify information associated with the target user and a suggestion to establish a connection to the recommended user to the user.
